(19) United States
(12) Patent Application Publication
(10) Pub. No.: US 2002/0154242 A1
(43) Pub. Date: Oct. 24, 2002

(54) Method and apparatus for generating multiple exposures in a digital camera

(76) Inventors: Mark N. Robins, Greeley, CO (US); Heather N. Bean, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/841,459

(22) Filed: Apr. 24, 2001

(51) Int. Cl. H04N 5/235

(52) U.S. Cl. 348/362

(57) ABSTRACT

A digital camera generates multiple exposures. In one embodiment of the present invention, a plurality of digital images are captured, and the digital images are combined to generate a multiple exposure. Optional techniques for image capture, weighting, and combining are also described.

### FIELD OF THE INVENTION

The present invention relates generally to digital cameras and more specifically to a method and associated apparatus for generating multiple exposures in a digital camera.

### BACKGROUND OF THE INVENTION

One special effect popular with photographers is the double exposure, in which a single frame of film is exposed twice to produce a photograph comprising two superimposed images. In general, a single frame of film may be exposed N times to produce a photograph comprising N superimposed images. The more general case is often referred to as a “multiple exposure,” of which the double exposure is a special case.

Digital cameras have become increasingly popular with both casual and serious photographers over the past several years. Unlike traditional silver-emulsion-film cameras, however, digital cameras are not designed to facilitate the creation of multiple exposures. One approach well known in the art is to post process two or more digital images using a compositing algorithm operating on a computing device separate from the digital camera. Creating a multiple exposure through post-processing provides a high degree of control over and precision in the finished product. However, some photographers desire digital cameras to behave as much like traditional silver-emulsion film cameras as possible, including the artistic technique of creating a multiple exposure “on the fly,” within the camera itself.

It is thus apparent that there is a need in the art for an improved digital camera and associated methods for generating multiple exposures.

### SUMMARY OF THE INVENTION

A method and associated apparatus are provided for generating multiple exposures in a digital camera.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a functional block diagram of a digital camera in accordance with the present invention.

FIG. 2 is a flowchart of the operation of the digital camera shown in FIG. 1 in accordance with one embodiment of the present invention.

FIG. 3 is a flowchart of the operation of the digital camera shown in FIG. 1 accordance with another embodiment of the present invention.

FIG. 4 is a flowchart of the operation of the digital camera shown in FIG. 1 in accordance with yet another embodiment of the present invention.

### DETAILED DESCRIPTION OF THE INVENTION

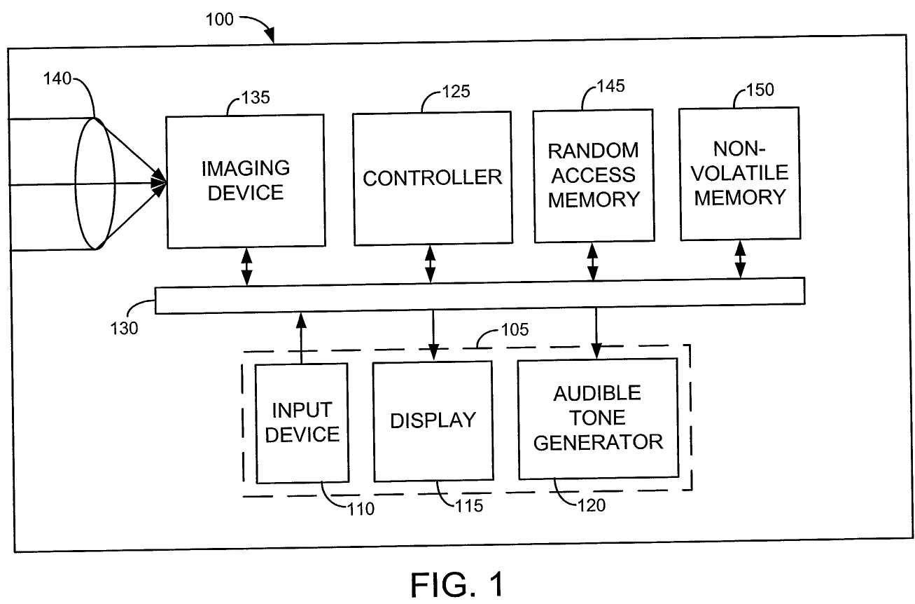

FIG. 1 is a functional block diagram of a digital camera 100 in accordance with one exemplary embodiment of the present invention. In FIG. 1, user interface 105 comprises input device 110, display 115, and optional audible tone generator 120. Input device 110 sends commands to controller 125 over data bus 130 to specify the modes of operation of digital camera 100. User interface 105 provides feedback to users via display 115 and optional audible tone generator 120. Imaging device 135 converts an optical image of a scene received from optical system 140 to a digital image. The digital image may be stored temporarily in optional random access memory (RAM) 145. Non-volatile memory 150 provides long-term storage of digital images.

In a typical implementation, imaging device 135 comprises a charge-coupled device (CCD), an analog-to-digital converter (A/D), a gain control, and a digital signal processor (DSP), as is well known in the art (not shown in FIG. 1). Input device 110 typically comprises one or more buttons for selecting modes and options in digital camera 100. Display 115 may optionally include the capability of displaying simultaneously a background digital image and an overlay image associated with a “preview mode” of digital camera 100. In preview mode, imaging device 135 rapidly samples whatever is received from optical system 140 in real time, and a low-resolution preview image of the scene is shown on display 115. The ability to display a background digital image and a superimposed preview image facilitates some embodiments of the present invention and will be discussed in more detail later in this description. Audible tone generator 120 is an optional component of digital camera 100 that may be used, for example, to signal when digital camera is ready to capture frames to generate a multiple exposure or to signal when a multiple exposure is complete. In some implementations, a flashing or persistent light, a vibrator, or other method of providing feedback to users may be preferable to an audible tone. Non-volatile memory 150 is typically flash memory but may, in some implementations, be of the removable type, such as a memory stick or magnetic disk.

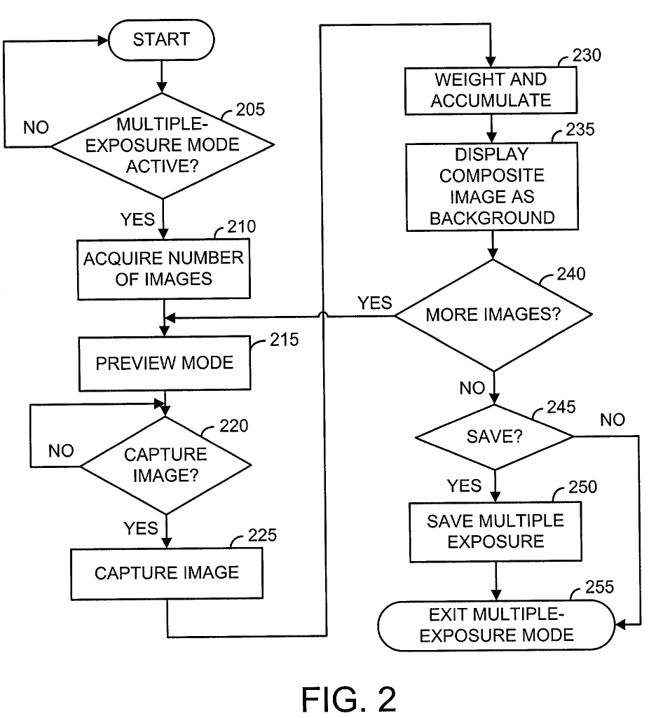

FIG. 2 is a flowchart of the operation of digital camera 100 in accordance with one embodiment of the present invention. At 205, controller 125 determines whether or not multiple-exposure mode is active. If so, the number of digital images N to be included in the multiple exposure is acquired at 210. In one implementation, a user inputs N via input device 110. Alternatively, the number of digital images to include may default to a previously specified value. At 215, digital camera 100 enters preview mode as explained in connection with FIG. 1. Upon receipt of a signal at 220, either from a user via input device 110 or another means such as a timer, digital camera 100 captures a digital image of the current scene at 225. The captured digital image may be saved in RAM 145. At 230, the digital image is summed with whatever other digital images have been captured previously in connection with the current multiple exposure. If the digital image captured at 225 is the first image captured in connection with a particular multiple exposure, the weighting and accumulation operations at 230 may be skipped. As is well known in the art, digital images may be summed by adding the color coordinates of their spatially corresponding pixels. This definition of summation will be used throughout this detailed description. The color coordinates may be Red, Green, and Blue (RGB), for example, but are not limited to this particular color space. Those skilled in the art will recognize that other color representations are possible, such as Cyan, Magenta, Yellow (CMY) or luminance/chrominance systems. Each individual color coordinate is typically represented using 8 to 12 bits in digital cameras. Since adding a plurality of digital images at 230 may result in overflow due to finite-word-length limitations, each digital image may also be weighted by a suitable factor. One simple approach is simply to weight each image by the reciprocal of the number of images being summed. That is, if N images are being accumulated, each image is weighted by 1/N at 230. In the special case of a double exposure, the weighting operation may be implemented as a right shift (division by two). However, unequal weighting of individual digital images comprising a multiple exposure is also possible and sometimes desirable. For example, earlier digital images captured in connection with a multiple exposure may be weighted more heavily than later digital images, or vice versa. In other embodiments, the user may input a specific weighting factor for each individual digital image using input device 110. More will be said about unequal weighting of images in a later portion of this description. At 235, the composite digital image formed thus far by weighting and accumulating digital images at 230 is shown on display 115. This allows a user to monitor the development of the multiple exposure after each individual digital image is captured. If at 240 no more digital images are to be captured in connection with the current multiple exposure, the option to save the multiple exposure may be presented to the user at 245. The user may, at 250, elect to save the multiple exposure to non-volatile memory 150 or to discard the multiple exposure and exit multiple-exposure mode at 255. If at 240 more images are to be captured in connection with the current multiple exposure, control returns to 215, where digital camera again enters preview mode. Whatever composite digital image has been formed through weighting and accumulating thus far is still shown as a background image on display 115, and the current scene received from optical system 140 is superimposed over the composite background image. This technique aids the photographer in composing successive digital images (exposures) comprising the multiple exposure and represents a capability unavailable in traditional film cameras.

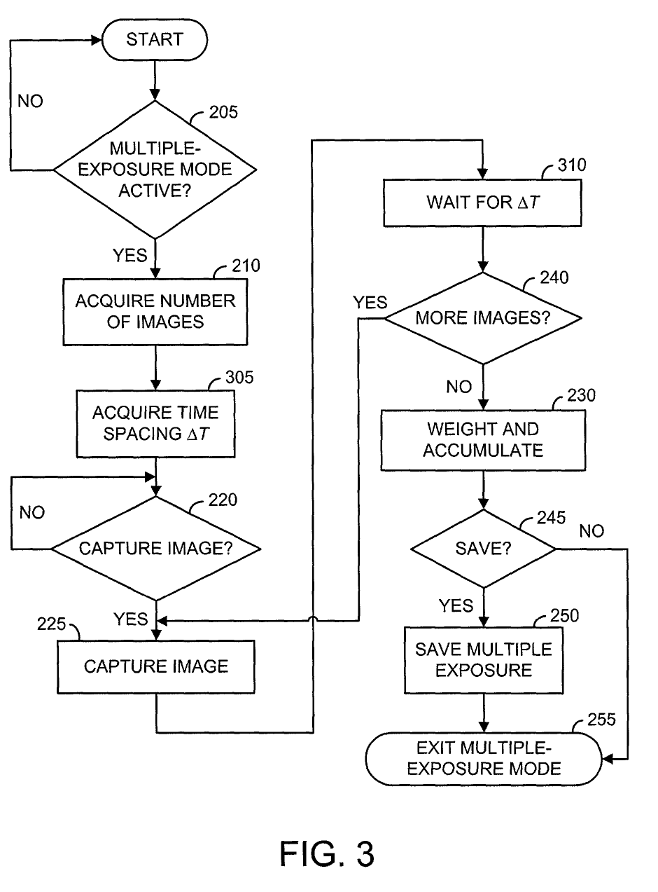

FIG. 3 is a flowchart of the operation of digital camera 100 in accordance with another embodiment of the present invention. In this particular embodiment, a specified number of digital images, typically of a single scene, are automatically captured at equally spaced time instants, equally weighted, and combined to form a multiple exposure. This embodiment makes possible in a digital camera a well-known technique in traditional silver-emulsion-film photography in which moving objects such as automobiles or pedestrians may be averaged out of a scene in a multiple exposure comprising a series of time-elapsed exposures of the same scene. In FIG. 3, controller 125 determines whether multiple exposure mode is active at 205. If so, the number of images to be included in the multiple exposure is acquired at 210. At 305, the time spacing ΔT between individual digital images is acquired. Acquiring the time spacing may comprise direct input from a user via input device 110, or the time spacing may default to a previously specified value. Once a signal has been received at 220, a digital image is captured at 225. A time delay of ΔT is measured at 310. If more digital images are to be captured in connection with the current multiple exposure, control returns to 225. Otherwise, the individual digital images are weighted and accumulated at 230 as explained in connection with FIG. 2. In this particular embodiment, the weighting is 1/N for N digital images. At 245, the option to save the multiple exposure may be presented. At 250, The resulting multiple exposure may be saved in non-volatile memory 150, or the multiple exposure may be discarded and multiple exposure mode exited at 255, as explained in connection with FIG. 2.

The particular embodiment shown in FIG. 3 is only one example of how the technique of averaging motion out of a scene in a multiple exposure may be implemented in digital camera 100. In variations of this embodiment, each individual digital image may be captured manually in response to user input via input device 110 instead of automatically, and the individual digital images comprising the multiple exposure need not be captured at equally spaced time instants. In general, the only requirements are that digital camera 100 remain stationary throughout a finite, predetermined period during which a series of time-elapsed digital images are captured and that the images are weighted and summed in such a manner that overflow is prevented.

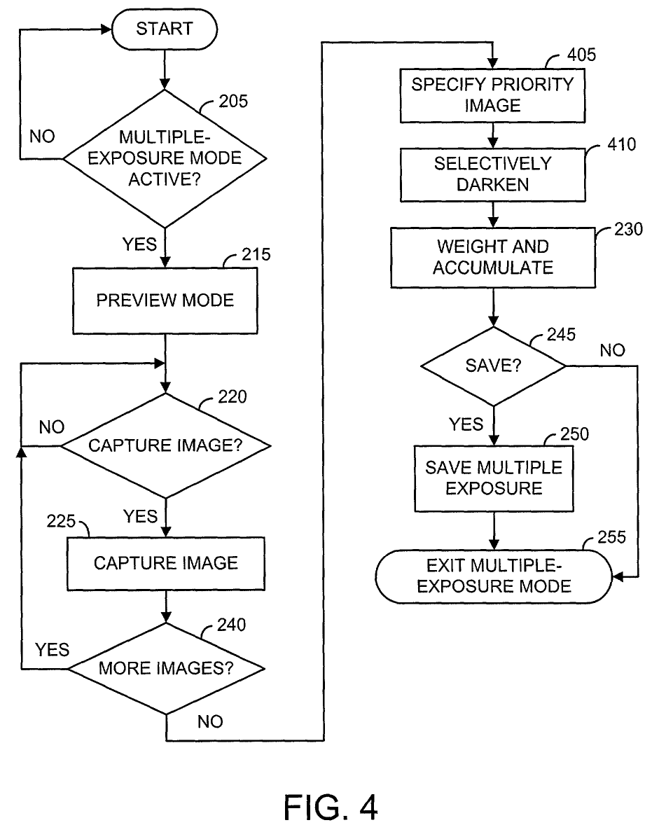

FIG. 4 is a flowchart of the operation of digital camera 100 in accordance with yet another embodiment of the present invention. This embodiment includes additional features for controlling the manner in which individual digital images are combined to generate a multiple exposure. This embodiment also illustrates that it is not necessary in all implementations of the present invention to input a priori the number of digital images to be included in a multiple exposure. At 205, controller 125 determines whether or not multiple exposure mode is active. If so, digital camera enters preview mode at 215. Upon receiving a signal at 220, a digital image is captured at 225. Image capture continues until, at 240, a signal is received to terminate image capture. The number of individual digital images captured may be determined easily from a simple counter in digital camera 100 (not shown in FIG. 1). At 405, the user may designate one of the captured digital images as a priority image. For example, the user may recall individual digital images to display 115 using input device 100 and input a command designating the currently displayed digital image as the priority image. The priority image is given precedence in subsequent color manipulation and weighting operations. At 410, the individual digital images may be analyzed to determine areas of color overlap. Optionally, selective areas of one or more of the individual digital images may be darkened so that the colors present in the priority image may prevail in those areas of the multiple exposure. Those skilled in the art will recognize that an image may be darkened by decreasing by an equal amount the color coordinates of each pixel within the area to be darkened. At 230, the individual digital images are weighted and accumulated. The weighting may be equal (1/N for N images, as explained previously), or the weighting may favor the priority image. For example, in a four-image multiple exposure, the second digital image may be designated as the priority image, and the four individual digital images, in chronological order of capture, may be weighted by 0.2, 0.4, 0.2, and 0.2, respectively. However, there is no requirement that all other digital images besides the priority image be equally weighted. As suggested in connection with FIG. 2, one possible weighting algorithm is that in which the first digital image captured is automatically designated as the priority image, and each subsequent digital image captured is weighted less heavily than the preceding digital image. The reverse of this scheme is also possible, in which the first digital image captured is weighted least heavily, and the last image captured, which is automatically designated as the priority image, is weighted most heavily. Alternatively, the user may input a specific weighting factor for each individual digital image via input device 110. From 230 forward in FIG. 4, control proceeds as explained in connection with FIG. 2.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for generating a multiple exposure in a digital camera, the method comprising:
entering a multiple-exposure mode in the digital camera;
capturing a plurality of digital images; and
automatically combining the plurality of digital images to generate the multiple exposure.

2. The method of claim 1, further comprising:
saving the multiple exposure.

3. The method of claim 1, wherein automatically combining the plurality of digital images to generate the multiple exposure comprises weighting and summing the plurality of digital images.

4. The method of claim 3, wherein each of the plurality of digital images is weighted by the reciprocal of the number of digital images being summed.

5. The method of claim 3, wherein the plurality of digital images are captured at successive time instants, and earlier digital images are weighted more heavily than later digital images.

6. The method of claim 3, wherein the plurality of digital images are captured at successive time instants, and later digital images are weighted more heavily than earlier digital images.

7. The method of claim 3, wherein the plurality of digital images are captured at successive time instants, and one predetermined digital image of the plurality of digital images is weighted more heavily than all other digital images.

8. The method of claim 1, wherein the plurality of digital images are captured at time instants distributed within a predetermined period.

9. The method of claim 1, wherein at least one portion of at least one of the plurality of digital images is darkened prior to automatically combining the plurality of digital images to generate the multiple exposure.

10. A method for generating a multiple exposure in a digital camera, the method comprising:
displaying simultaneously a background digital image and a superimposed preview image;
capturing a digital image of the preview image; and
combining the background digital image and the digital image of the preview image to generate the multiple exposure.

11. The method of claim 10, further comprising:
saving the multiple exposure.

12. The method of claim 10, wherein the background digital image comprises a composite of a plurality of digital images.

13. A digital camera, comprising:
an optical system;
an imaging device for converting optical images received from the optical system to corresponding digital images;
a memory for storing the digital images; and
a controller configured for combining the digital images.

14. The digital camera of claim 13, further comprising:
a display configured for displaying simultaneously a first digital image and a superimposed preview image.

15. The digital camera of claim 13, further comprising:
an input device for specifying the number of digital images to be combined.

16. The digital camera of claim 13, further comprising:
an input device for specifying a weighting factor for each of the digital images to be combined.

17. A digital camera, comprising:
means for collecting optical images;
means for converting the optical images to corresponding digital images;
means for storing the digital images; and
means for combining the digital images.

18. The digital camera of claim 17, further comprising:
means for displaying simultaneously a first digital image and a superimposed preview image.

19. The digital camera of claim 17, further comprising:
means for specifying the number of digital images to be combined.

20. The digital camera of claim 17, further comprising:
means for specifying a weighting factor for each of the digital images to be combined.
